(19) United States
(12) Patent Application Publication
(10) Pub. No.: US 2009/0199610 A1
(43) Pub. Date: Aug. 13, 2009

(54) ACTUATOR, PARALLEL LINK MECHANISM USING THE SAME, AND LONG MATERIAL BENDING DEVICE

(75) Inventors: Shinjiro Sato, Yokohama-shi (JP); Ken Ichiryu, Sagamihara-shi (JP); Takuya Hachinohe, Tokyo (JP)

Correspondence Address: BROWDY AND NEIMARK, P.L.L.C.;624 NINTH STREET, NW, SUITE 300, WASHINGTON, DC, 20001-5303, US

(73) Assignee: KIKUCHI SEISAKUSHO CO., LTD., TOKYO (JP)

(21) Appl. No.: 11/911,084

(22) PCT Filed: Apr. 4, 2005
(86) PCT No.: PCT/JP2006/307076

§ 371 Date: Feb. 2, 2009

(30) Foreign Application Priority Data
Apr. 6, 2005 (JP) 2005-109846

(51) Int. Cl. F16H 25/20; F16H 21/10; B21D 5/06; B21D 5/00

(52) U.S. Cl. 72/169; 74/89.33; 74/479.01; 72/306

(57) ABSTRACT

The dimensions of the fitting part of an actuator are to be dramatically reduced while enabling control items such as a driving motor and a position sensor of standard designs to be fitted around outside the actuator. To achieve this purpose, the actuator is provided with a trunnion type universal joint including: a fitting shaft, holding members and a rotary block having a nut arranged in it; a ball screw that is screwed into the nut of the universal joint and, being operationally linked to a driving power source, can move the nut back and forth; and a ball screw guide that is provided on the universal joint and guides the back-and-forth moving direction of the ball screw.

### BACKGROUND OF THE INVENTION

1. Field of the Invention

The present invention relates to a ball screw type actuator suitable for use in machining pipes, rods and shapes, a parallel link mechanism using the same, and a long material bending device.

2. Description of the Related Art

Actuators of this kind, parallel link mechanisms using one or another of such actuators, and various machine tools have been known. One example is disclosed in Patent Document 1. This machine tool includes a frame, a table to mount a work on, a main shaft head for holding a tool, plural driving devices (actuators) for driving the main shaft head with a ball screw, and an NC device for controlling the driving devices. In this particular machine tool, the middle part of the ball screw is supported by a penetrating type universal joint to permit inclination relative to the top plate of the frame, and the tip of the ball screw is directly linked to a universal joint to permit inclination relative to the main shaft head. A nut, screwed on to this ball screw, is coupled to be turnable by a motor. Controlling the number of revolutions of the motor with the NC device on the basis of the required number of revolutions of the ball screw around the shaft and the required extent of its transfer in the axial direction causes the ball screw to turn around the shaft integrally with the universal joint and to move in parallel in the axial direction (parallel link mechanism), and causes the main shaft head to be regulated in the target position and posture. In this machine tool, as the middle part of the ball screw is fitted to the fitting plate (top plate) with a penetrating type universal joint, the fixed side supporting point can be set to any desired position of the actuator, the fitting part of the actuator can be reduced in size.

Patent Document 1: JP-A No. 241526/2001

However, when a mechanism in which the middle part of a ball screw is fitted to a fitting plate (top plate) with a penetrating type universal joint as in the conventional machine tool described above is to be applied to a long material bending device shown in FIG. 1, it is possible to use a somewhat smaller top plate than in the usual fitting arrangement for the actuator (the tip of the actuator is fitted to a movable plate through a usual type universal joint and its rear end is fitted to the fitting plate through a similar universal joint) shown in FIG. 2, but it is difficult to substantially reduce the dimensions of the fitting plate where a penetrating type universal joint, whose center is penetrated by the actuator, is used because the universal joint bulges around outside the actuator and, moreover, the cost inevitably increases because control items such as a driving motor and a position sensor of standard designs cannot be fitted around the actuator.

An object of the present invention, attempted to solve these problems inherent in the conventional mechanisms, is to provide an actuator of this kind, a parallel link mechanism using the same, and a long material bending device, in which the size of the fitting part of the actuator is dramatically reduced to configure the whole device compactly by use of a novel universal joint system for the actuator, control items such as a driving motor and a position sensor of standard designs are enabled to be fitted around outside the actuator to reduce the manufacturing cost, and the distance between the fixed side supporting point and the movable supporting point of the actuator is shortened to enhance safety against buckling and increase mechanical rigidity

### SUMMARY OF THE INVENTION

In order to achieve the object stated above, an actuator according to the invention is provided with a trunnion type universal joint including a fitting shaft, holding members arranged on the fitting shaft to be rotatable around the core of the fitting shaft and protruding in the direction of the core of the fitting shaft, and a rotary block pivoting between the holding members to be rotatable in a direction orthogonal to the rotating direction of the holding members and having a nut arranged between the two rotating ends; a ball screw that is screwed into the nut of the trunnion type universal joint and, being operationally linked to a driving power source, can move the nut back and forth; and a ball screw guide including a guide block fixed over the rotary block of the trunnion type universal joint and having a guide part parallel to the core of the nut and a guide shaft of which one end is fixed to the driving power source side and which is capable of engaging with the guide part of the guide block and guiding the back-and-forth moving direction of the ball screw.

A parallel link mechanism according to the invention comprises a base plate; a movable plate provided with a tool in the central part thereof; and six expansion devices fitted between the base plate and the movable plate and each including the actuator referred to above and a universal joint provided at a tip of the actuator, wherein the six expansion devices are so coupled to the peripheries of both plate faces as to constitute a substantial truss shape, and the movable plate is moved by the back-and-forth motions of the actuator with three degrees of freedom in parallel and three degrees of rotational freedom relative to XYZ coordinates set on the base plate.

A long material bending device according to the invention is provided with a bending head for bending a long material in a curved shape, a material feeding device for feeding the bending head with long materials and a control system for controlling the bending head and the material feeding device, wherein the bending head includes a base plate with a guide pipe having a guide hole to let a long material supplied from the material feeding device be inserted erected in its central part, a movable plate with a die for applying a bending force to the long material delivered from the guide pipe while letting the forward-fed long material be inserted provided in its central part, and six expansion devices installed between the base plate and the movable plate and each including the actuator referred to above and a universal joint provided at a tip of the actuator, wherein the six expansion devices are so coupled to the peripheries of both plate faces as to constitute a substantial truss shape, and the movable plate is moved by the back-and-forth motions of the actuator with three degrees of freedom in parallel and three degrees of rotational freedom relative to XYZ coordinates set on the base plate. In this case, the control system controls the length of the actuator by setting the position and inclination of the movable plate relative to the bending plate and the torsional angle of the movable plate around the center axis thereof.

The actuator according to the invention is enabled by the trunnion type universal joint of the above-described configuration to select the position of the fixed side supporting point as desired and to be compact in overall configuration of the actuator by dramatically reducing the dimensions of the fitting part of the actuator. Moreover, control items such as a driving motor and a position sensor of standard designs are enabled to be fitted around outside the actuator to reduce the manufacturing cost. Furthermore, the distance between the fixed side supporting point and the movable supporting point of the actuator can be shortened to enhance safety against buckling and increase mechanical rigidity.

The parallel link mechanism using the actuator according to the invention is enabled by the actuator of the above-described configuration to select the position of the fixed side supporting point as desired and to be compact in overall configuration of the parallel link mechanism by dramatically reducing the dimensions of the fitting part of the actuator. Moreover, control items such as a driving motor and a position sensor of standard designs are enabled to be fitted around outside the actuator to reduce the manufacturing cost. Furthermore, the distance between the fixed side supporting point and the movable supporting point of the actuator can be shortened to enhance safety against buckling and increase mechanical rigidity.

The long material bending device using the actuator according to the invention is enabled by the actuator of the above-described configuration to select the position of the fixed side supporting point, to dramatically reduce the dimensions of the fitting part of the actuator while securing a sufficient moving range for the movable die, and to reduce the size of the bending head to make the overall configuration of the bending device compact. Moreover, control items such as a driving motor and a position sensor of standard designs are enabled to be fitted around outside the actuator to reduce the manufacturing cost. Furthermore, the distance between the fixed side supporting point and the movable supporting point of the actuator can be shortened to enhance safety against buckling and increase mechanical rigidity.

### BRIEF DESCRIPTION OF THE DRAWINGS

FIG. 1A shows a schematic front view of the configuration of a machine tool using a conventional parallel link mechanism, and FIG. 1B shows a schematic profile of this conventional machine tool;

FIG. 2A shows a schematic front view of the configuration of a machine tool using a conventional usual parallel link mechanism, and FIG. 2B shows a schematic profile of this conventional machine tool;

FIG. 3 shows a perspective view of the configuration of an actuator, which is a preferred embodiment of the present invention;

FIG. 4A shows a schematic front view of the configuration of a long material bending device into which a parallel link mechanism using the actuator, which is the preferred embodiment of the invention, is incorporated, and FIG. 4B shows a schematic profile of the long material bending device into which the parallel link mechanism using the actuator is incorporated;

FIG. 5 shows a perspective view of the parallel link mechanism using the actuator; and

FIG. 6A shows a schematic front view of the configuration of a parallel link mechanism using the actuator, which is the embodiment of the invention, in another mode, and FIG. 6B, a schematic profile of the parallel link mechanism in the other mode using the actuator.

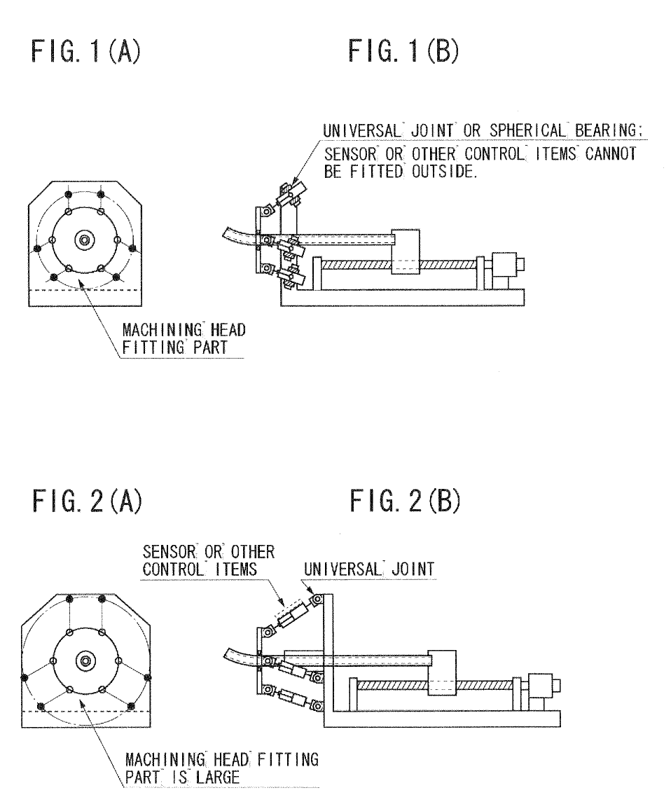

### DESCRIPTION OF THE PREFERRED EMBODIMENT

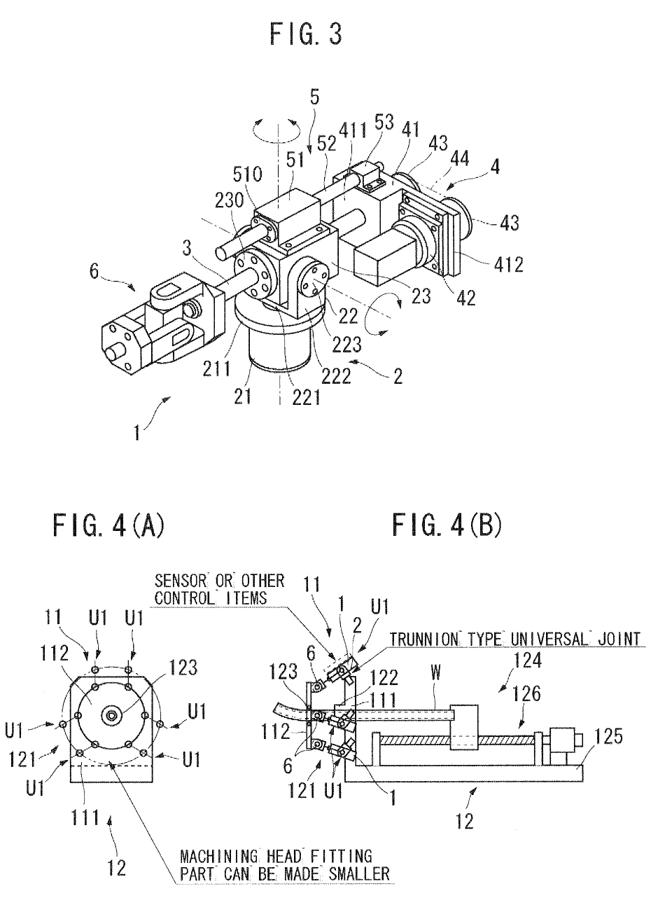

A preferred embodiment of the present invention will be described below with reference to drawings. FIG. 3 shows a perspective view of the configuration of an actuator, which is the embodiment of the invention. Referring to FIG. 3, an actuator 1 is provided with a trunnion type universal joint 2, a ball screw 3, a driving unit 4 for a ball screw and a ball screw guide 5 as its basic constituent elements, each of which will be described in detail below.

The trunnion type universal joint 2 includes a fitting shaft 21, a holding member 22 and a rotary block 23. In this case, the fitting shaft 21 includes a cylindrical member having a flange 211 at its upper end (one end), and a bearing is arranged on its inner circumferential face. This fitting shaft 21 may have any external shape, such as a rectangular shape. The holding member 22, formed of a groove-shaped member, has a base 221 in the middle and a holding part 222 on each side of it. A shaft (not shown) is fixed downward onto the center of the lower face of the base 221, and a supporting shaft 223 is fitted to each of the holding parts 222. The shaft on the lower face of this holding member 22 is inserted onto the inner circumferential face of the fitting shaft 21, and arranged to be rotatable in the horizontal direction around the core of the fitting shaft 21 over (the upper face of) the fitting shaft 21 to protrude both holding parts 222 in the direction of the core of the fitting shaft 21. The rotary block 23, which is a rectangular block longer sideways, has a nut insertion part between its two end faces, and a nut 230 is fitted in this insertion part. This rotary block 23 is supported between the holding parts 222 of the holding member 22 by the supporting shaft 223 to be rotatable in the vertical direction (a direction orthogonal to the rotating direction of the holding member 22). This rotary block 23 may have any desired external shape, cylindrical, pyramidal or spherical.

A usual ball screw is used as the ball screw 3, and screwed into the nut 230 in the rotary block 23. The base of the ball screw is operationally linked to the driving unit 4. In this case, the driving unit 4 includes a driving unit frame 41, a driving motor 42 with a built-in encoder, a pair of pulleys 43 and 43, and a timing belt 44 is wound around these pulleys 43 and 43. The driving unit frame 41 has on one of its faces a ball screw insertion supporting part 411 and a motor fitting part 412. A bearing is fitted to the ball screw insertion supporting part 411, the ball screw 3 is inserted into this ball screw insertion supporting 411, and one of the pulleys 43 is fitted to a shaft end (base end) protruding from the other face of the driving unit frame 41. The tip side of the driving motor 42 is inserted into the motor fitting part 412 and fixed, and the other pulley 43 is fitted to the driving shaft protruding from the other face of the driving unit frame 41. The timing belt 44 is wound between these pulleys 43 and 43.

The ball screw guide 5 includes a guide block 51 and a guide shaft 52. In this case, the guide block 51 is a rectangular block longer sideways and smaller than the rotary block 23, a hole parallel to the core of the nut 230 is bored between its two end faces, and a linear guide (linear bush) is fitted in this hole to constitute a guide part 510. This guide block 51 is fixed to the upper face of the rotary block 23. A linear shaft slidable in the guide part 510 of the guide block 51 is used as the guide shaft 52. This guide shaft 52 is inserted into and engaged with the guide part 510 of the guide block 51, and its base is fixed by a fixing member 53 fitted to the upper part of the ball screw insertion supporting 411 of the driving unit frame 41. On the other hand, a usual type universal joint 6 is coupled to the tip of the ball screw 3 via an idling mechanism using a thrust roller bearing.

The actuator 1 is configured as described above, with its middle part fixed to a fitting plate for the actuator 1 by the fitting shaft 21 of the trunnion type universal joint 2 and the universal joint 6 at its tip fitted to a movable plate. This fitting structure of the actuator 1 enables the fixed side supporting point to be selected as desired and the trunnion type universal joint to function equally to the conventional penetrating type universal joint. Moreover, the dimensions of the fitting plate can be made significantly smaller than in conventional usual type and penetrating type universal joints to enable the whole actuator 1 to be compactly configured. Incidentally, where the actuator 1 is to be used in an upright position, the installation space of the device can be reduced. Furthermore, as the space outside the actuator 1 is opened unlike in the conventional penetrating type universal joint, control items such as a driving motor and a position sensor of standard designs can be fitted around outside the actuator in simple structures to reduce the manufacturing cost. Furthermore, the distance between the fixed side supporting point and the movable supporting point of the actuator can be shortened to enhance safety against buckling and increase mechanical rigidity. This increased rigidity makes the actuator 1 applicable to pressing as well.

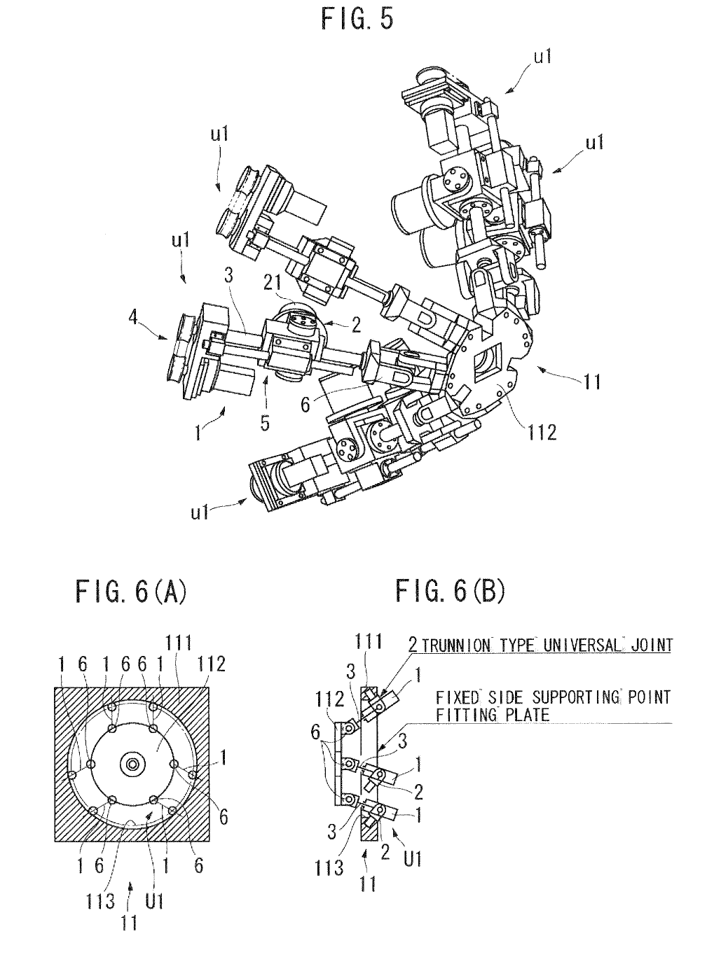

This actuator 1 has a structure effective for use in parallel link mechanisms and long material bending devices incorporated into various machine tools. Next, a parallel link mechanism using the actuator 1 will be described with reference to FIG. 4A, FIG. 4B and FIG. 5. FIG. 4A shows a schematic front view of the configuration of a long material bending device into which the parallel link mechanism using the actuator, which is the preferred embodiment of the invention, is incorporated. FIG. 4B is a schematic profile of the long material bending device into which the parallel link mechanism using the actuator is incorporated. FIG. 5 shows a perspective view of the parallel link mechanism using this actuator.

Referring to FIG. 4A and FIG. 4B, a parallel link mechanism 11 incorporated into this long material bending device 12 includes a base plate 111, a movable plate 112 having a tool arranged in its central part, actuators 1 fitted between the base plate 111 and the movable plate 112, and six expansion devices U1 each formed of an actuator 1 and a universal joint 6 fitted to the tip of the actuator 1. These six expansion devices U1 are so coupled to the peripheries of both plate faces as to constitute a substantial truss shape as shown in FIG. 5, and is caused by the motions back and forth of the actuators 1 to move the movable plate 112 with three degrees of freedom in parallel and three degrees of rotational freedom relative to coordinates XYZ coordinates set on the base plate 111.

By use of the trunnion type universal joint 2 at the fixed side supporting point of each of the actuators 1 in the parallel link mechanism 11 in this way, the dimensions of the base plate 111 of the actuators can be made significantly smaller than in conventional usual type and penetrating type universal joints to enable the whole parallel link mechanism 11 to be compactly configured. Incidentally, where the actuators 1 are to be used in an upright position, the installation space of the device can be reduced. Furthermore, as the space outside each actuator 1 is opened unlike in the conventional penetrating type universal joint, control items such as a driving motor and a position sensor of standard designs can be fitted around outside in simple structures the actuator to reduce the manufacturing cost. Furthermore, the distance between the fixed side supporting point and the movable supporting point of the actuator can be shortened to enhance safety against buckling and increase mechanical rigidity. This increased rigidity makes the parallel link mechanism 11 applicable to pressing as well.

Incidentally in the parallel link mechanism 11 shown in FIG. 4A, FIG. 4B and FIG. 5, the fitting shaft 21 of the trunnion type universal joint 2 is fitted to the outer circumference of the base plate 111 inward as seen from the rotary block 23. However, it is also possible to fit the fitting shaft 21 outward as seen from the rotary block 23 to the inner circumference of a round hole 113 bored in the base plate 111 as shown in FIG. 6A and FIG. 6B. This configuration enables the inner space of the fixed side supporting point to be freely used. This space can be utilized for many purposes such as placing the work in and out, bringing in other items, handing various things.

Next, a long material bending device using the actuators 1 will be further described with reference to FIGS. 4A and 4B. Referring to FIG. 4, this bending device 12 includes a bending head 121, a material feeding device 124 which feeds long materials to the bending head 121, and a control system (not shown) which controls the bending head 121 and the material feeding device 124.

The bending head 121 includes the base plate 111 with a guide pipe 122 having a guide hole to let an inserted long material W be erected in its central part, the movable plate 112 with a die 123 for applying a bending force to the long material W delivered from the guide pipe 122 provided in its central part, and six expansion devices U1 installed between the base plate 111 and the movable plate 112. Each of the expansion devices U1 includes an actuator 1 and a universal joint 6 formed at its tip, and the middle part of each actuator 1 is fitted to the periphery of the base plate 111, and the universal joint 6 at the tip is fitted to the rear face periphery of the movable plate 112. It is preferable for the movable plate 112 to be smaller than the base plate 111 in external size so as not to interfere with the bending of the long material W. In this way, the bending head 121 constitutes a six-axis parallel link mechanism which is caused by the expansion and contraction of the expansion devices U1 to move the movable plate 112 with three degrees of freedom in parallel and three degrees of rotational freedom, or a total of six, relative to the base plate 111.

The trunnion type universal joint 2 is fitted on the base plate 111 side at two points having between them, and at an equal distance to, each of points dividing into three equal parts the circumference of an imaginary circle formed around the center of the base plate 111 on the outer circumference of the base plate 111, while the universal joints 6 are fitted on the movable plate 112 side at two points having between them, and at an equal distance to, each of the points dividing into three equal parts the circumference of an imaginary circle formed on the same plane as the rear face of the movable plate 112 and formed around the center of the movable plate 112. The six expansion devices U1 are installed in a substantial truss shape spanning, in a state in which a triangle linking the points dividing the base plate 111 into three equal parts and a triangle linking the points dividing the movable plate 112 are off each other by a rotational angle of 180°, the six pairs of fitting positions at the shortest distance between the base plate 111 and the movable plate 112.

In this six-axis parallel link mechanism, xyz right-angle coordinates are set with the center of the guide pipe 122 as the origin in front of the base plate 111 and the z axis constitutes the guide pipe 122. Further, a uvw right-angle coordinates are set with the center of the die 123 fitted to the movable plate 112 as the origin; the w axis constitutes the center axis of the die 123 and the uv plane is on the same plane as the plane of the mold cavity of the die 123. By expanding or contracting the six expansion devices U1, the center point of the movable plate 112, in other words the center point of the die 123, is moved in parallel in the three directions of the xyz axes set on the base plate 111 and rotated around each of the uvw axes set on the movable plate 112. Thus the movable plate 112 moves with three degrees of freedom in parallel and three degrees of rotational freedom, oar total of six, relative to the base plate 111. Incidentally in the bending head 121, the offset of the center point of the die 123 from the core of the guide pipe 122, the distance from the front face of the guide pipe 122 to the center point of the die 123 (the inter-mold distance) and the angle of inclination of the die 123 relative to the face orthogonal to the core of the guide pipe 122 are set as parameters.

The material feeding device 124, including a frame 125 fixed to the rear part of the bending head 121 and an actuator 126 installed on that frame 125, pushes ahead the rear end of the long material W with the actuator 126 to feed the long material W through the guide pipe 122 of the bending head 121. A dent or a clamp for fixing the terminal end of the long material W is provided at the tip of the actuator 126. A guide roller may be disposed as required between the actuator 126 and the guide pipe 122 to prevent the long material W from buckling.

The control system is composed of a personal computer. The personal computer computes the length of each expansion device U1 from the input values of machining parameters, operates the actuator 1 to control the position and posture of the movable plate 112 relative to the bending head 121, and also controls the speed of feeding the long material W by the actuator 126 of the material feeding device 124. As the machining parameters differ with the shape, size, stuff and other aspects of the long material, they are figured out by experiment and stored in advance.

The long material W that can be machined with this bending device 12 may be a pipe, rod, shape or belt having a circular, oval or angular section, and any such long material W can be machined into a spiral shape by bending it to a certain radius in the direction of the plate thickness and at the same time twisting it. When a belt whose cross section is curved or angled and asymmetric between right and left is to be bent, the torsional distortion due to the bending can be compensated for by twisting it.

By use of the trunnion type universal joint 2 at the fixed side supporting point of the actuator 1 of the bending head 121 in this way, the dimensions of the fitting plate of the actuator 1 can be made significantly smaller than in conventional usual type and penetrating type universal joints, and at the same time, while securing a sufficient moving range for the movable die 123, the whole bending device 12 can be configured compactly by reducing the size of the bending head 121. Where the actuators 1 are to be used in an upright position, the installation space of the device can be reduced. Furthermore, as the space outside each actuator 1 is opened unlike in the conventional penetrating type universal joint, control items such as a driving motor and a position sensor of standard designs can be fitted around outside in simple structures the actuator to reduce the manufacturing cost. Furthermore, since the distance between the fixed side supporting point and the movable supporting point of the actuator 1 can be shortened, safety against buckling can be enhanced and mechanical rigidity increased.

Although the present invention has been described with reference to a preferred embodiment thereof illustrated in the drawings, it must be evident to persons skilled in the art that the invention can be readily altered or modified, and such alterations are included in the scope of the invention.

What is claimed is:

1. An actuator comprising:
a trunnion type universal joint including a fitting shaft, holding members arranged on the fitting shaft to be rotatable around the core of the fitting shaft and protruding in the direction of the core of the fitting shaft, and a rotary block pivoting between the holding members to be rotatable in a direction orthogonal to the rotating direction of the holding members and having a nut arranged between the two rotating ends;
a ball screw that is screwed into the nut of the trunnion type universal joint and, being operationally linked to a driving power source, can move the nut back and forth; and
a ball screw guide including a guide block fixed over the rotary block of the trunnion type universal joint and having a guide part parallel to the core of the nut and a guide shaft of which one end is fixed to the driving power source side and which is capable of engaging with the guide part of the guide block and guiding the back-and-forth moving direction of the ball screw.

2. A parallel link mechanism comprising:
a base plate;
a movable plate provided with a tool in the central part thereof; and
six expansion devices fitted between the base plate and the movable plate and each including the actuator according to claim 1 and a universal joint provided at a tip of the actuator,
wherein the six expansion devices are so coupled to the peripheries of both plate faces as to constitute a substantial truss shape, and the movable plate is moved by the back-and-forth motions of the actuator with three degrees of freedom in parallel and three degrees of rotational freedom relative to XYZ coordinates set on the base plate.

3. A long material bending device provided with a bending head for bending a long material in a curved shape, a material feeding device for feeding the bending head with long materials and a control system for controlling the bending head and the material feeding device,
wherein the bending head includes:
a base plate with a guide pipe having a guide hole to let a long material supplied from the material feeding device be inserted erected in its central part,
a movable plate with a die for applying a bending force to the long material delivered from the guide pipe while letting the forward-fed long material be inserted provided in its central part, and
six expansion devices installed between the base plate and the movable plate and each including the actuator according to claim 1 and a universal joint provided at a tip of the actuator,
wherein the six expansion devices are so coupled to the peripheries of both plate faces as to constitute a substantial truss shape, and the movable plate is moved by the back-and-forth motions of the actuator with three degrees of freedom in parallel and three degrees of rotational freedom relative to XYZ coordinates set on the base plate.

4. The long material bending device according to claim 3, wherein the control system controls the length of the actuator by setting the position and inclination of the movable plate relative to the bending plate and the torsional angle of the movable plate around the center axis thereof.
